(19) United States
(12) Patent Application Publication
(10) Pub. No.: US 2005/0108516 A1
(43) Pub. Date: May 19, 2005

(54) By-pass and tampering protection for application wrappers

(76) Inventors: Robert Balzer, Sante Fe, NM (US); Neil Goldman, Marina del Rey, CA (US)

Correspondence Address: Benedict O'Mahoney, 1800 Embarcadero Road, Palo Alto, CA, 94303, US

(21) Appl. No.: 10/826,584

(22) Filed: Apr. 16, 2004

Related U.S. Application Data
(60) Provisional application No. 60/463,770, filed on Apr. 17, 2003.

(51) Int. Cl. H04L 9/00

(52) U.S. Cl. 713/150

(57) ABSTRACT

In a computer system with an operating system that supports multiple levels of interfaces (APIs) that application programs (i.e. programs executing outside the operating system kernel in user mode) can invoke to obtain services from the operating system, and the employment of a hooking or mediation technology within a user-mode process (i.e. an instantiation of an application program) to intercept/mediate invocations of selected interfaces of some of those levels, the Tampering Protection protects the code and statically or heap allocated data of the mediators from corruption by the code of the user-mode process being mediated that resides and operates in the same address space as the code and data of the mediators (as such corruption would compromise the integrity of the mediator and could prevent it from accomplishing its intended mediation purpose). It does so by providing memory protection services that allow mediators to define data areas (both static segments and dynamic heaps) to be protected and to temporarily unprotect them during the execution of a mediator so that they can be modified during that execution, thus ensuring that the mediate application does not directly use the operating system services to override Tampering Protection management of these protected segments or protected.

### CROSS-REFERENCE TO RELATION APPLICATIONS

This application claims the benefit of PPA Ser. No. 60/463,770, filed 2003 Apr. 17 by the present inventors.

### FEDERALLY SPONSORED RESEARCH

The invention described herein was developed under Federal Contract # 057715, Prime: F30602-99-1-0542.

### SEQUENCE LISTING OR PROGRAM

Object code listing on appendix CD.

### BACKGROUND OF INVENTION

1. Field of Invention

The present invention relates to the security of communications between applications and the operating system in a computer based system.

2. Prior Art

System Services in modern operating systems are capabilities implemented by the operating system kernel, or executive, modules. These modules typically restrict an application's employment of these services based on account and resource configuration settings. A complex architecture relying on both hardware and software components is required to ensure that the intended restrictions are enforced on all application programs at all times.

The hardware, as embodied in a particular central processing unit (CPU) will provide two or more “privilege” levels. At any time, the CPU is executing at one of these levels. The CPU will refuse to execute certain instructions when executing at a level other than the most privileged. Furthermore, blocks of virtual memory are associated with the privilege levels. Machine instructions that read or write to memory will signal faults if the memory address is associated with a more privileged level than that at which the CPU is executing.

Because binary code itself resides in the virtual memory, the assignment of privilege levels to memory implicitly assigns privilege levels to code. The CPU's ordinary control transfer instructions will signal faults if the target instruction resides in memory that has a different (or at least more privileged) level than that at which the CPU is executing.

The CPU provides special instructions for changing privilege levels. These instructions bundle the functionality of changing levels with a control transfer. They are designed to allow an operating system to restrict the possible entry points into its privileged code.

The software architecture that an operating system constructs on top of this CPU hardware allows the authors of privileged code to protect resources by writing code that conditionalizes manipulation the resources with tests of authorization restrictions, with a guarantee that the tests cannot be circumvented. This protection only extends to unprivileged code—privileged code (at least code with the highest privilege level) can easily circumvent this protection.

During bootstrapping, the CPU is running at the most privileged level, and the operating system's bootstrapping code sets up privileged memory areas and loads its native system service code into that memory. In particular, this privileged code places restrictions on the ability to add any additional code to privileged memory, or to add any additional entry paths into privileged memory. Ordinary applications and the data they manipulate, is forced to reside in least privileged memory and execute at the CPU's least privileged level.

Unprivileged programs or libraries can neither add their own secure restrictions on access to resources protected by the operating system, nor can they invent new kinds of resources with secure access protection.

Object Oriented programming languages provide forms of encapsulation the can provide much of this security to application programs within the restricted realm of unprivileged application code created by the OO programming language compiler, but cannot provide security against arbitrary malicious, or buggy, binary code from other sources.

3. Objects and Advantages

ByPass Protection: User mode control of a selected set operating system services by Trusted Code operating in an application process, either through interfaces provided by that Trusted Code or mediation of those operating system services through their documented public APIs, is comprehensive—i.e. it can't be bypassed even by malicious code.

Tampering Protection: User mode controllers operating within this Trusted Code can withstand attacks by malicious code to modify and/or disable that Trusted Code. Safely Used for Security Purposes: User mode mediators of operating system services, which have better visibility into process behavior and are easier to write than kernel-mode mediators, can be safely employed for security purposes because they are protected from bypass and tampering (both modification and disablement).

Safely Used for Digital Rights Management: User mode controllers, such as Digital Rights Managers, that provide service to untrusted code through interfaces they define, can be safely employed because the services they are protecting can not be obtained directly or indirectly from the operating system (i.e. their control of those services can not be bypassed) and they are protected from tampering (both modification and disablement).

ByPass Protection: All ByPass exploits are thwarted. No matter what path is taken to invoke protected operating system services, the invocation is blocked unless it occurs within the user-level Trusted Code. This ByPass protection applies to both known and unknown exploits.

UnForgeable, UnSpoofable Enter-Trusted-Code Signal: The critical Enter-Trusted-Code signal, which determines whether user-level invocations of protected operating system services should be allowed (because they occur within the Trusted Code) or blocked (because they are bypass attempts occurring outside the Trusted Code—i.e. in the untrusted code), is a reliable communication path that can't be forged or spoofed.

Memory Protected Trusted Code Data: All global and heap Trusted Code data, whether static or dynamic, is memory protected except while it is being updated by the Trusted Code. The Trusted Code data is logically and physically partitioned into separate functional areas so that only a single area needs to be unlocked for Trusted Code update at any point in time.

Memory Protected Mediation Interception: User level mediators can be installed by a binary patch to the entry code of the API they are mediating. To prevent their removal or disablement, the Tampering Protection can restore the memory protection of this code (read and execute allowed, but write prohibited) after the patch is installed, and then, through its own mediators, ensures that the wrapped application does not directly use the operating system services to modify the memory protection of this code.

### SUMMARY

In a computer system with an operating system that supports multiple levels of interfaces (APIs) that application programs (i.e. programs executing outside the operating system kernel in user mode) can invoke to obtain services from the operating system, and the employment of a hooking or mediation technology within a user-mode process to intercept/mediate invocations of selected interfaces of some of those levels, the ByPass Protector blocks the direct use of any lower-level interfaces on which the mediated interface depends. Within any thread of the mediated application only invocations of the dependent lower-level interfaces occurring within this region are allowed. Other invocations are ByPasses of the user-level mediators and cause the process to be terminated by the ByPass Protector mediator. The Enter-Trusted-Code signal is made non-forgeable and non-spoofable by registering the address(es) from which it will be invoked during the loading of the application (before any of its code has been executed), and arranging the user-level mediator code so that this call occurs at the head of the code that actually enters the mediator, so that even if the malicious code transfers to this location after “spoofing” the stack instead of invoking the user-level mediator through a normal call, the user-level mediator will still be entered and perform its function properly on the “spoofed” parameters—thus turning the “spoofed” stack and transfer into just an unconventionally encoded invocation

### DRAWINGS

### Figures

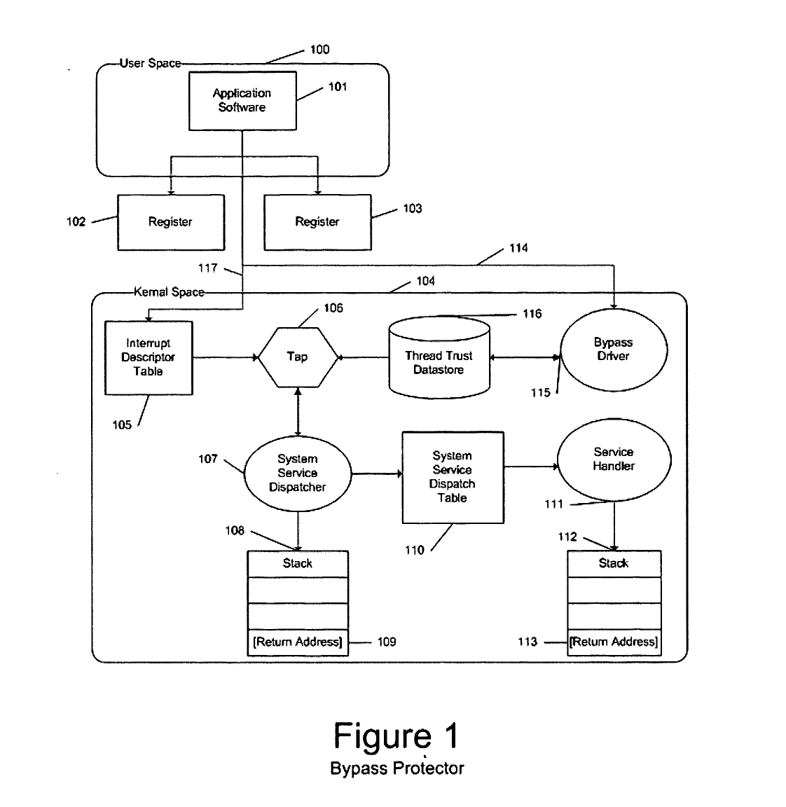

FIG. 1 illustrates the Bypass Protector.

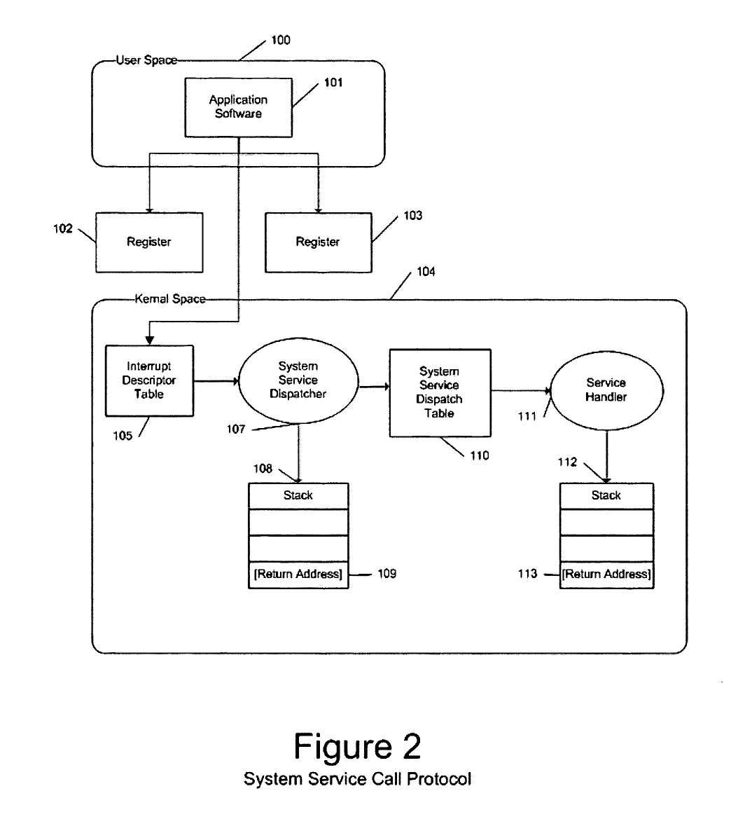

FIG. 2 illustrates the Windows System Service Handling.

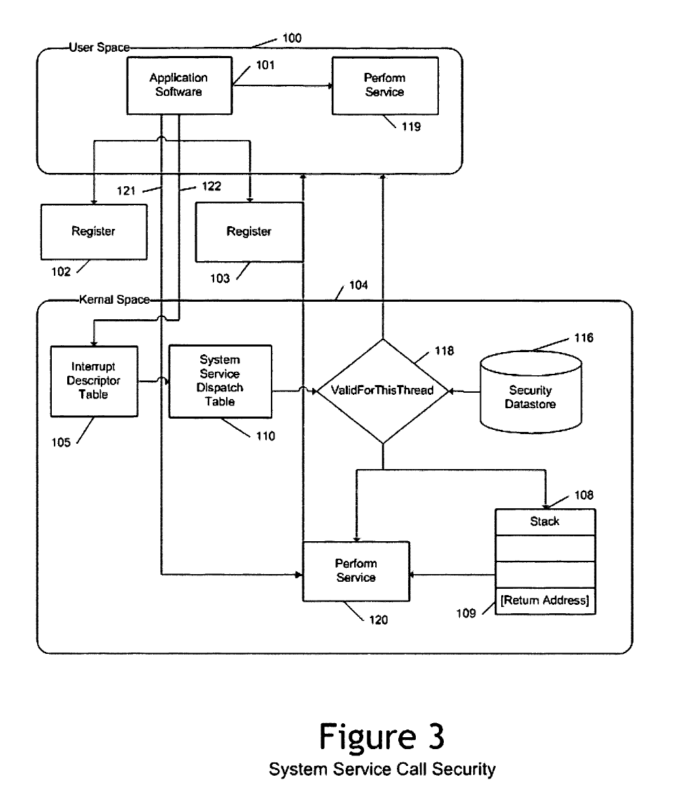

FIG. 3 illustrates the security of the System Service Handling Protocol.

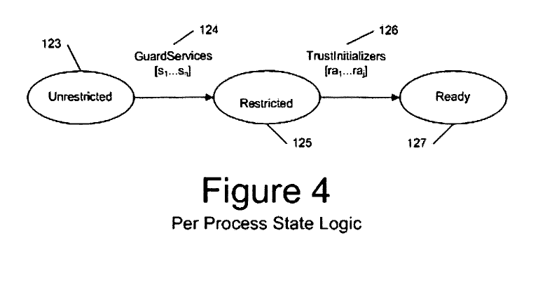

FIG. 4 illustrates the Per Process State Transitions of the Bypass Protector.

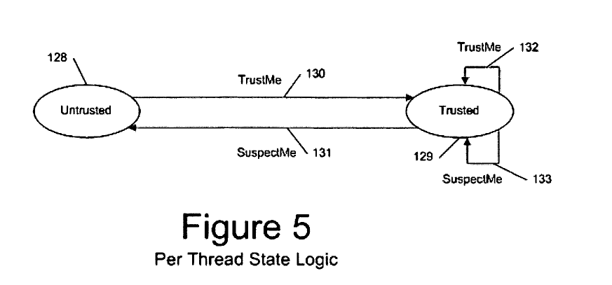

FIG. 5 illustrates the Per Thread State Transitions of the Bypass Protector.

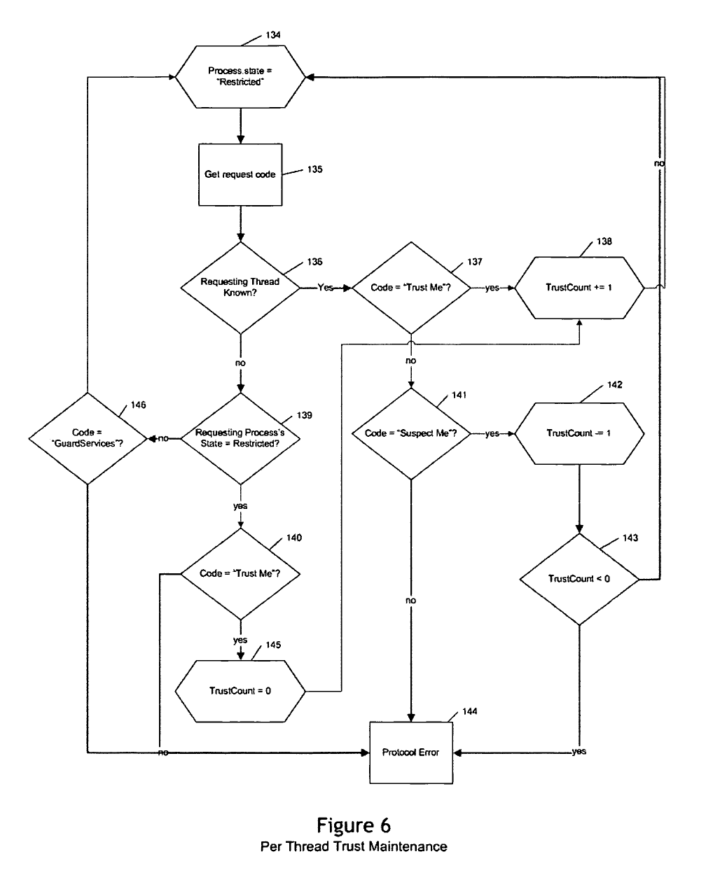

FIG. 6 illustrates the Bypass Protector logic.

### REFERENCE NUMERALS

100—User space
101—Application software
102—EAX Register
103—EDX Register
104—Kernal space
105—Interrupt Descriptor Table
106—Tap
107—System Service Dispatcher
108—Stack
109—Return Address
110—System Service Dispatch Table
111—Service Handler
112—Stack
113—Return Address
114—Bypass Protocol
115—Bypass Driver
116—Thread Store Datastore
117—Service Request
118—Check for valid thread process
119—Spoofed Perform Service process
120—Perform Service process
121—Direct transfer
122—Service Request
123—Unrestricted state
124—Guard Services protocol notice
125—Restricted state
126—Trust initializers protocol notice
127—Ready state
128—Untrusted state
129—Trusted state
130—Trust Me protocol notifications
131—Suspect Me protocol notifications
132—Trust Me protocol notifications
133—Suspect Me protocol notifications
134—Process to check if State is restricted.
135—Process to obtain the request code.
136—Decision based on whether the Thread is known.
137—Decision based on whether Code=“Trust Me”.
138—Process to Increment the TrustCount.
139—Decision based on whether Process's Thread=Restricted.
140—Decision based on whether Code=“Trust Me”.
141—Decision based on whether Code=“Suspect Me”.
142—Process to decrement TrustCount.
143—Decision based on whether TrustCount is greater than 0.
144—Protocol Error.
145—Process to initialize TrustCount.
146—Decision based on whether Code=“GuardServices”.

### DETAILED DESCRIPTION—PREFERRED EMBODIMENT

Bypass Protection and Tampering Protection are achieved by augmenting the native operating system's software architecture for the invocation of system services. Understanding how those augmentations yield a system supporting secure trusted code intervals in application code requires a basic understanding of the principles behind the native architecture itself.

Regarding the native operating system service invocation protocol, FIG. 2 depicts the native Windows Operating System's software architecture for secure employment of System Services by application code.

An application program [101] running at user-mode privilege [100] first places a service number in the microprocessor's EAX register [102], and places the address of a block of parameter values required by the service in the EDX register [103]. The application then invokes the microprocessor's Software Interrupt instruction (assembly language mnemonic int) with the immediate operand hexadecimal value 2E.

In practice, applications do not deal with this machine language interface. Instead, they invoke functions exported from Microsoft-supplied libraries, which directly, or indirectly through other Microsoft-supplied libraries, invoke code that actually writes the registers and runs the int2E instruction.

The int instruction treats its operand as an index into a vector called the Interrupt Descriptor Table [105]. The members of this vector are Gate Descriptors. The address of this table is kept in a register that cannot be written by user-mode code. As part of booting, Windows sets this register to point to a block of memory that cannot be modified by user-mode code, and fills the entry indexed by 2E with values that comprise an Interrupt Gate Descriptor. Interrupt gates are one of several mechanisms provided by the Intel microprocessor for switching privilege levels. Although the processor provides four levels, Windows only makes use of two of them—Level 3 (aka User Mode) and Level 0 (aka Kernel Mode). The data written by the bootstrapping code into entry 2E specifies a transfer to Kernel Mode, and the address of a function in the Windows kernel (the system service dispatcher (aka KiSystemService) [107]) to which control should be transferred. The int instruction copies the values in several hardware registers to the kernel stack [108] for the calling thread (so they can be restored on return), as well. Among these are the stack pointer register (ESP) containing the address of the top of the thread's user-mode stack, and the instruction pointer (EIP) register, containing the address of the instruction following the int2E instruction [109].

The CPU is now running at privilege level 0, executing the system service dispatcher. This code treats the service number (still present in the EAX register) as an index into a System Service Dispatch Table (ssdt) [110], a vector in kernel memory allocated and initialized during the bootstrapping of the OS. The low-order 12 bits of the service number act as an index into a dispatch table; the next two higher-order bits select one of four possible tables. In practice, one table is used for a set of services implemented in the binary win32k.sys, which contains user interface related services. A second table is used for the services implemented in ntoskrnl.exe. The indexed entry provides KiSystemService with the address of the kernel function that implements the requested service and how many parameter bytes are expected by that function. If the index is valid, KiSystemService copies the parameters from user mode memory (the base address to copy from is still in the EDX register) onto the kernel stack [112], and then calls the designated kernel function.

The designated Service Handler [111] now executes. The return address into KiSystemService has been pushed onto the thread's kernel stack [112], above the parameter values that were copied by KiSystemService. The Service Handler must check the parameter values for validity. Some checking may have already been done by the user-mode library code through which the application invoked the service—e.g., null pointer checks—but the Service Handler can neither rely on that nor reliably determine whether the call arrived via such a path. The Service Handler performs the service, including checking any authorizations that may be required for the service with the parameters requested. The Service Handler returns a result value in the EAX register. When the Service Handler returns, control passes back to KiSystemService. It is responsible for copying parameter values back to the user mode stack (since some may be OUT mode parameters), maintaining the result in the EAX register was stored there by the Service Handler. Ultimately, the code executes the IRETD instruction, which is the return side of the int2E instruction—it pops the register values stored by int2E off the thread's kernel-mode stack, restoring them to the registers. IRETD also puts the processor back into privilege level 3, before allowing control to resume at the instruction located at RA.

In regards to the security of the native implementation, the complexity of this protocol, and the reason for the user-mode/kernel-mode split in responsibilities, is that it allows the operating system services themselves to be written as ordinary functions, yet ensures that the intended restrictions on access to resources provided through the services are enforced on all application programs. Understanding why the system service call protocol provides such security relies on several fundamental observations. FIG. 3 highlights the security factors.

A Service Handler [FIG. 1—111] can be coded as
if ValidForThisThread(Parameters) [118] then PerformService(Parameters) [1 20] with assurance that application code [101] cannot execute PerformService directly by transferring control to it [121]. The CPU ensures that only means for control to transfer from user mode to kernel mode is through gates, such as the int2E interrupt gate, which ensures that the validity check will protect PerformService.

All the kernel-mode code, including that comprising ValidForThisThread and PerformService, is protected from being overwritten by instructions executed in application code. This is because the protected code resides kernel-mode memory segments, and the CPU prevents user mode code from altering that memory. Data on which the service relies [1 16], such as access control lists, thread account ids, and the thread's kernel stack reside in kernel-mode memory and so are safe from tampering.

The contents of the Interrupt Descriptor Table [105] and the System Service Dispatch Table [110] reside in kernel-mode memory and so are safe from tampering. The register holding the address of the IDT can only be written by kernel mode code. CPU registers, which will hold data and instruction addresses during the execution of the Service Handler, are properly saved and restored if the OS decides to perform a thread switch while the thread is in kernel mode.

Nothing prevents a user-mode program from writing and transferring control to a sequence of machine instructions in user mode [119] identical to that executed by PerformService. So the only sense in which a system service can be providing any security is that it relies on execution of some instruction(s) that the CPU will not execute from user mode, or that it relies on altering the contents of kernel-mode memory. Also note that nothing prevents other kernel-mode code from tampering with the code or data of the service or executing a copy of the same instructions—security only extends to protection from user-mode code.

In the augmented implementation and protocol, the Bypass Protection and Tampering Protection are enabled by the addition of two components to the Operating System kernel and use of a protocol by application code to establish trusted execution intervals in specific execution threads. FIG. 1 depicts these components and the protocol.

The Interrupt Gate Descriptor in entry 2E of the Interrupt Descriptor Table [105] is modified so that its target address is a new piece of kernel-resident code, the SSD Tap [106]. Each service request is therefore intercepted by the SSD Tap, which checks the Thread Trust Database (TTDB)[116] to see if the calling thread is currently trusted to invoke the requested service (the service is identified by the value in the EAX register). If the thread is trusted, the SSD Tap transfers control, via a jump (jmp) instruction, to the native System Service Dispatcher [107] (whose address was replaced in Interrupt Gate Descriptor 2E). The SSD Tap ensures that the stack pointer, the stack, and all registers contain the same values they held at the time it intercepted the request. This ensures that the System Service Dispatcher will see the same context it would have seen had the Tap not been inserted. If the calling thread is not currently trusted to invoke the requested service, the SSD Tap will kill the calling thread or process (if so configured) or return an error result to the caller (e.g., by passing control to the System Service Dispatcher as in an approved request, but with an invalid service index in the EAX register).

A kernel-mode driver not present in the native OS, the Bypass Driver [115], accepts DeviceIoControl calls from user-mode code. The per-process logic of the Bypass Driver, which is identical for each process, implements the simple state diagram depicted in FIG. 4. The per-thread logic of the Bypass driver implements a second simple state machine, depicted in FIG. 5. The latter state machine determines the dynamic trust of a thread with respect to system services by modifying the contents of the Thread Trust Database [116]. FIG. 6 depicts the detailed logic within the Bypass Driver that implements these state machines.

A newly created process is (initially) unrestricted [123]. All threads of an unrestricted process are treated as trusted for all services. This is the interpretation of having no entry for a thread's process in the TTDB.

The first time any thread of a process sends the GuardServices control code [124,146], a set of guarded services is established for all threads (current and future) of the calling process. The GuardServices control code is accompanied by an array of service numbers. An entry is added to the TTDB for the calling process, containing a record of the service numbers to be guarded. The process is now in the restricted state [125,134]. All current threads of the process are treated as untrusted for the guarded services, but trusted for all other services. This is the interpretation of the TTDB for a thread that no entry in the TTDB when its process is restricted. A consequence of this treatment is that any newly created threads of a restricted process are initially untrusted for the guarded services.

When a thread of a restricted process sends a TrustMe [130/132, 137] control code, that thread's trust count in the TTDB is incremented by one [138]. If the thread has no entry in the TTDB [140], one created with an initial trust count of 0 [145], then incremented to 1 [138].

When a thread with an entry in the TTDB having a trust count greater than zero sends a SuspectMe [130/133, 141] control code, its entry's trust count is decremented by one [142].

A thread with a trust count greater than zero is treated as trusted for all services. A thread with a trust count of zero is treated the same as a thread with no entry—i.e., untrusted for its process's guarded services, but trusted for others. In other words, the untrusted state[128] of a thread corresponds to the condition TrustCount=0, and the trusted state[129] corresponds to the condition TrustCount>0.

All other DeviceIoControl control codes to the Bypass Driver are invalid [144]. Depending on configuration, the calling thread or process will be terminated, or the caller will simply receive an error result and have no impact on the TTDB.

The Bypass Driver registers with the OS kernel (PsSetCreateProcessNotifyRoutine) to be notified of process termination. When a process is terminated, all records involving that process and its threads are removed from the TTDB. The Bypass Driver registers with the OS kernel (PsSetCreateThreadNotifyRoutine) to be notified of thread termination. When a thread is terminated, all records involving that thread are removed from the TTDB. This protocol requires a properly programmed thread to contain pairings of TrustMe and SuspectMe control codes. These pairings may nest. A programmer who writes the code segment
DeviceIoControl(hBypassDriver,TrustMe, . . . );
TrustedCode( );
DeviceIoControl(hBypassDriver,SuspectMe, . . . );
   is authorizing a particular invocation of the subroutine TrustedCode to execute with no restrictions on its use of system services (beyond those imposed by the native OS itself). Although programs typically pair TrustMe/SuspectMe control codes at the same lexical program scope, the logical pairing is purely dynamic and bears no necessary connection to program lexical scope. The execution of code in a thread between a TrustMe/SuspectMe pair is referred to as a trusted interval.

With regards to tampering protection, all user-mode code assumes in its operational design that the program's code and (much of) the data manipulated by that code are “tamper-proof”—that is, they will not change except as directed by the program itself. Very few programs actually modify their own code, whereas all programs modify some of the non-code portion of their virtual memory during execution. The native operating system makes it unlikely that accidental programmer errors will result in code modification, or that one application will modify another's data. However, the native operating system does not make the code and data tamper-proof. Malicious code running in a process can easily modify that program's code or its data without the program being made aware of the modification.

Because a trusted interval portion of an application is still embodied in user-mode code, it is subject to modification by other, untrusted, application code. Malicious modifications to trusted interval code, or to the user-mode data which that code manipulates, could nullify the benefits of restricting employment of guarded services to this code. Tampering Protection prevents such modifications.

The binary code portion of a program's address space generally comprises code memory segments from multiple executable files, including one or more libraries supplied by the operating system vendor. The “data” portion of the address space includes both “globally” allocated storage segments from these files, “heap” allocated storage allocated “on-demand” by the operating system as the program runs, “stack” storage allocate by the operating system as threads are created, and memory-manned files. In addition to this virtual memory, programs use the microprocessor's hardware registers as temporary storage and rely on these being “tamper-proof” as well. The Windows OS allows individual pages of virtual memory to be placed in a write-protected state. While in this state, any attempt by a program to alter the contents of that memory page will fail, and an exception will be raised. Windows provides a user-mode library utility, VirtualProtect, to change the read/write/execute protection status of a contiguous range of virtual memory pages. The following steps are required to protect trusted code and its data:

Identify the code pages that might contain code executed as part of trusted intervals. If necessary, perform one or more calls on VirtualProtect to ensure that those pages are set to PAGE_EXECUTE_READ status. For code compiled and linked with Microsft's tools, binary code pages are by default allocated to a “.text” segment that is initialized to this state, so no VirtualProtect calls are necessary to accomplish this. Identify any global (static) memory on which trusted code depends. Arrange for that storage to be allocated in named data segments. When compiling code with Microsoft's C/C++ compiler, the data_seg pragma and _declspec(allocate . . . )) declarator can be used to force allocation into selected segments. In the binary modules initialization code, after initializing the values of these variables, execute calls on VirtualProtect to initialize these segments to PAGE_READONLY status. Use multiple segments as suggested by the volatility of the storage allocated in that segment. One segment, for example, should hold storage that will be initialized at program startup and never needs to be modified thereafter.

Identify dynamically allocated memory on which trusted code depends. Logically partition this memory according to its volatility. For example, one partition may consist of memory that is allocated and initialized at process startup, based on configuration parameters, and never written thereafter. Other partitions may contain storage that is only allocated/deallocated/written as part of certain infrequent process lifecycle events, such as creating a thread or establishing a database connection. Other partitions may need to have storage frequently allocated/deallocated/written.

For each partition identified in step 3, allocate a dynamic heap (HeapCreate) as part of process initialization. Store the handles returned by HeapCreate in the least volatile static memory segment identified in step 2.

Whenever it is necessary to allocate (additional) memory identified in step 3, allocate it on the heap created in step 4 for that partition. Windows provides the HeapAlloc API for this purpose, but some programming languages (notably C++) provide linguistic means (operators, templates) that can be used to encapsulate an association between types and heaps, which commonly matches the partitioning identified in step 3.

Ensure that any allocation, deallocation, or writing of the memory identified in step 3, and any writing of the static memory identified in step 2, occurs with the corresponding heap or data segment in a writeable status. Use VirtualProtect with PAGE_READWRITE to make a heap or segment writable, and with PAGE_READONLY to return it to a non-writeable status. This pair of calls establishes a volatile interval for the heap or segment.

During the time that a memory segment or heap is writable, it can be modified not only by the thread that established the volatile interval, but by other threads of the process as well (or, with suitable permissions, by other user-mode processes). This provides a window of opportunity for any malicious code that could be running in those other threads. The ramifications of this are:

Keeping the volatile interval short is advisable—don't include (lengthy) computations unrelated to the memory update within a volatile interval.

Smaller partitions are preferable to larger ones. Ideally, only the pages that actually need to be updated would be made writeable, but in general it is not practical, or even possible, to achieve such a fine granularity.

Never execute obviously suspicious code inside a volatile interval. Even though the code is subject to Bypass Protector restriction, it can still modify the writeable memory because virtual memory updating does not require access to any system service.

In regards to securing the Bypass Driver and Tampering Protector, although the kernel augmentation and protocol usage described above allow a “cooperative” program to dynamically control system service access in its threads, it does not prevent malicious code in a program from accessing those services in unintended ways. Likewise, the Tampering Protection, as described above, allows cooperative code to limit its own updates to sensitive memory, but does not in itself prevent malicious code from gaining update access to that memory. The remaining portion of the Bypass Protector constitutes a means of dealing with the same security concerns addressed by the OS system service call architecture.

Code such as TrustedCode( ) in the fragment above can be written as
if ValidForThisThread(Parameters) then PerformService(Parameters)
   where PerformService invokes one of the process's guarded services with assurance that malicious code cannot execute PerformService directly by transferring control to it. If a direct transfer were made, the SSD Tap would reject the use of guarded services by PerformService, because it would occur while the calling thread was not trusted. The user-mode code, containing ValidForThisThread and PerformService can be protected from being overwritten by malicious user-mode code by placing tampering protection on the memory segments containing the code.

User-mode data on which trusted code relies is held in memory segments with tampering protection.

The contents of the TTDB is safe from corruption by user-mode code because it resides in kernel memory. Likewise, the code comprising the Bypass Driver and the SSD Tap are safe from corruption because they reside in kernel memory.

CPU registers, which will hold data and instruction addresses during the execution of the unrestricted user-mode code, are properly saved and restored by the OS if it decides to perform a thread switch while the thread is executing as trusted code.

Nothing prevents a user-mode program from writing and executing its own sequence of instructions:
DeviceIoControl(hBypassDriver,TrustMe, . . . );
   TrustedCode( );
   DeviceIoControl(hBypassDriver,SuspectMe . . . );
      in user memory. To thwart this, we extend the Bypass Driver protocol and its SSD Tap functionality as follows.

The DeviceIoControl(hBypassDriver,TrustMe, . . . ) calls from an application should be implemented as inline machine language. Because DeviceIoControl is just a user-mode library interface to a system service, this open coding includes a sequence of machine instructions:
mov eax,ZwDeviceIoControlFileGate ;; numeric value is OS-specific
mov edx,esp ;; arguments include the TrustMe control code
int 2Eh

An additional control code, TrustInitializers, is accepted by the Bypass Driver [126]. The driver will accept only the first request sent by a process using this code, and it must follow the GuardServices request from the same process. The data accompanying the TrustInitializers code is an array of 32-bit user mode memory addresses. These are the addresses of the instructions following the “int 2Eh” instructions—one for each open-coded TrustMe call in the program. The array of addresses is associated with the process in the TTDB. Upon receipt of this code, the driver places the process in the ready state in the TTDB [127].

A minor augmentation of the logic in FIG. 6 implements the extra transition in the state diagram. The TrustInitializers code transitions a process's state from “Restricted” to “Ready”. TrustMe codes are now only accepted in the protocol for threads of processes whose state is Ready, not those whose state is restricted. When the Bypass driver receives a TrustMe control code from a process, it verifies that the return address (RA) is one of those associated with the calling process in the TTDB. If it is not, the request is considered a “spoofing” attempt. Depending on the configuration, the requesting thread or process will be terminated, or the requester will simply receive an error result and the TrustMe request will not be granted. Although the SuspectMe calls could be secured in an analogous fashion, spoofed SuspectMe calls do not afford a means to executed guarded services from outside a thread's intended dynamic period of trust. A spoofed SuspectMe call during a non-trusted period will be detected immediately by the Bypass driver [143]. A spoofed SuspectMe call during a trusted period will simply result in a premature end to a trusted period, in which case (i) a system service request that should be trusted will be rejected, with consequences dependent on configuration, and (ii) the valid SuspectMe call that should terminate a trusted period will be interpreted as invalid, with consequences dependent on configuration.

Nothing prevents a user-mode program from writing and executing its own sequence of instructions:
VirtualProtect(pSensitiveMemory, sz, PAGE_READWRITE, . . . );
CopyMemory(pSensitiveMemory, sz, pMaliciousCodeOrData);

However, the Bypass Protector can easily be configured to detect such a malicious attack. VirtualProtect relies on a system service, NtProtectVirtualMemory, to actually carry out the status change. Malicious code can be prevented from changing the protection of sensitive memory pages by including NtProtectVirtualMemory among the system services guarded by a process [124], and by ensuring that the VirtualProtect calls that demarcate volatile intervals for sensitive memory occur only within trusted intervals of the calling thread.

For most practical purposes, it is necessary for logic in a trusted interval to rely on the contents of machine registers written by code executing in untrusted intervals. For example, if trusted interval code can be used from multiple threads of a process, it is generally necessary to provide parameters to it on the thread's user-mode stack, which means the code relies on the content of the stack pointer register. Even for single-threaded applications, it is generally more convenient to supply parameters on the stack than in global variables. Malicious code written by a programmer who is aware of how trusted code relies on specific registers can load a register with a value that will cause the trusted code to throw an exception, prior to jumping directly to the inline TrustMe code. If done properly, the thread would enter trusted mode and then raise an exception. If the malicious code established its own SEH exception handler in the calling thread prior to this, it could gain control while the thread is still in a trusted state, and therefore employ guarded services without passing through the intended validity checking. To prevent this, the user-mode code must disable existing SEH handlers in the calling thread after the TrustMe request returns (i.e., following the int 2E instruction in the inline-coded version), but before executing any code that could raise an exception due to improper register contents. For an Intel CPU, the assembly language instruction:
mov fs:[0],0
   will suffice to block outer exception handlers from view.

If the calling thread has exception handlers scoped around the trusted interval, then it must save the contents of fs:[0] prior to setting it to zero, and restore it following return from the matching SuspectMe request. This is handled by passing the value to be saved to the driver as data accompanying the TrustMe request. The driver retains the (stack of) saved addresses in kernel memory, popping the stack and returning the saved value as return data with each value SuspectMe request.

In an example embodiment, the Bypass Protector and Tampering Protector concepts are employed in two distinct scenarios. In the first, the source code of an application is written to identify specific system services to be guarded and include explicit TrustMe/SuspectMe notices establishing trusted intervals around the code that employs those system services. The reason for employing the Bypass Protector or Tampering Protector in this situation may simply be program self-monitoring (to guard against programmer error, analogous to the common practice of including Assert macros in source code), or for security reasons, as would be the case if, for example, the application dynamically loaded and executed untrusted code attached to documents. Use of the Bypass Protector to block access to system services from dynamically loaded and executed untrusted code in the above scenario is quite limiting, because it blocks all access to those services, independent of context or parameters. This motivates the second usage scenario, in which the trusted code acts as a filter on requests for the guarded services originating in untrusted code. Filtering is accomplished by mediating (rerouting) the indirect requests for those services originating in the untrusted code. The untrusted code makes an indirect request by invoking an API exported from a user-mode library. (In practice, these indirect requests are the only way that non-malicious applications actually invoke system services on the Windows platform.) The low-level means of dynamically patching binary code in virtual memory to accomplish this mediation are in the public domain—the article “Galen C. Hunt, Doug Brubacker, Detours: Binary Interception of Win32 Functions Proceedings of the 3rd USENIX Windows NT Symposium, July 1999, pp. 135-43.” contains an excellent explanation. In this scenario, the API calls from untrusted code are rerouted to code that begins a trusted interval, inspects the context and API call parameters to determine whether to approve or reject the call, and (conditional on approval) routes invokes the original API by a means that won't be rerouted. When the latter call returns, the trusted code closes the trusted interval.

This more flexible use of the Bypass Protector may be embodied either in an application executable that loads and executes untrusted code, or in an application library that is injected into an untrusted executable. Once the trusted and untrusted code have become part of the same process, it is immaterial what originated as an executable and what originated as a library. In this more flexible use of the Bypass Protector, security is enhanced by also employing the Tampering Protector to prevent malicious corruption of the trusted code or its data—most specifically, any virtual address space resident data on which the filtering of requests for guarded services depends.

With regards to establishing a Bypass and/or Tamper Protected Process, the first step of establishing a protected process is to install the Bypass Driver, which initializes the kernel-resident portion of the architecture. Typically the driver is included with other drivers auto-installed when the Windows OS boots, but it could be installed anytime prior to beginning the following steps.

The trusted module of the protected process may be loaded into the process before or after the untrusted portion. The two scenarios described above present an example of each. The trusted module should do the following, in the order listed:

Obtain from the OS (via the CreateFile API), and retain in virtual memory, a handle to the Bypass Driver. This is needed to send DeviceloControl requests to the driver. Initialize the content of all data segments and heaps that are to be tamper-protected, and then set them to be unwriteable. (Include the handle obtained in step 1 in a protected segement—preferably one that remains unwriteable for the lifetime of the process). Do not place the VirtualProtect call(s) for this step within trusted intervals, because it is too soon to establish trusted intervals in the process.

Send the GuardServices code to the driver, passing an array of system service indices to be guarded. The index of a particular system service may depend on which version of the OS is being used, so for a trusted code binary to be version-independent it must use GetVersionEx to determine the platform version.

Send the TrustInitializers code to the driver, passing an array of the int2E return addresses for the inline TrustMe calls found in code in the trusted module.

If employing the scenario requiring mediation of untrusted code, install the mediators. Steps 1, 2, 3 and 4 can be executed from the initialization code of the trusted module. Step 5 can typically also be performed in the trusted module's initialization code. Note that installation of mediators does not require that the untrusted code already be present in the process, only that the libraries containing the APIs to be mediated are present. Until step 4 has been carried out, the Bypass Driver is not restricting the process's use of system services. For totally untrusted binary modules in a security-sensitive application, therefore, at least steps 1-4 should be completed before the untrusted module is even allowed to run its own initialization code. One means of accomplishing this in the case where the untrusted module is an executable image, rather than a library or embedded macro, is sketched in the following (full details of this method can be found in numerous web postings):
1) Start a new process, via the executable image, with its initial thread suspended. (Call the CreateProcess API, with the CREATE_SUSPENDED flag.)
2) Inject the trusted module (implemented as a dyamic link library), into the new process by
3) Allocate a block of virtual memory in the new process (use VirtualAllocEx)
4) Mark the block of virtual memory as executable (use VirtualProtectEx)
5) Write machine instructions into the block of memory that will load the trusted library (code to call LoadLibrary)
6) Create a new thread in the new process, with the start of code written in the previous step as the thread's starting address (use CreateRemoteThread)
7) Block until the new thread terminates (use WaitForSingleObject)
8) Resume the suspended original thread (use ResumeThread) of the new process.

The untrusted module's initialization code does not run until the original thread is resumed. But the initialization of the trusted module is executed as part of LoadLibrary. The net effect is to establish the necessary Bypass Protector and Tampering Protector context before any code from the untrusted module has executed.

1. A computer system including an operating system and software applications, the system comprising:
a central processing unit;
means for storing and retrieving programs and data connected with said central processing unit;
an operating system stored in said means for storing and retrieving programs and data;
a plurality of software applications stored in said means for storing and retrieving programs and data;
a plurality of application threads, wherein each of said threads is associated with a single one of said software applications;
a plurality of bypass protocols that interface with said software applications, wherein each of said bypass protocols is associated with a single one of said software applications;
a bypass driver that interfaces with said bypass protocols, wherein the specific state of trust of each of said application threads of said software applications associated with said bypass protocols is obtained by said bypass driver from said bypass protocols;
a thread trust datastore that interfaces with said bypass driver, wherein the state of trust of said software applications is communicated from said bypass driver to said thread trust datastore and stored in memory; and
a system service dispatch tap that interfaces with said operating system, wherein invocations of services from said operating system by said software applications are intercepted by said system service dispatch tap, the state of trust of said software application is obtained from said thread trust datastore, and said invocation of service is routed in said operating system based upon said state of trust.

2. The computer system including an operating system and software applications of claim 1, wherein said operating system is a Microsoft Windows® based operating system.

3. The computer system including an operating system and software applications of claim 1, wherein said central processing unit is an Intel®-based microprossor.

4. The computer system including an operating system and software applications of claim 1, wherein said invocation of service is terminated if the value of said state of trust of said software application is negative.

5. A computer system including an operating system and software applications, the system comprising:
a central processing unit;
means for storing and retrieving programs and data connected with said central processing unit;
an operating system stored in said means for storing and retrieving programs and data;
a plurality of privilege levels associated with said central processing unit;
a plurality of software applications stored in said means for storing and retrieving programs and data, wherein each of said applications is associated with a single one of said privilege levels;
a plurality of application threads, wherein each of said application threads is associated with a single one of said software applications;
a plurality of driver modules stored in said means for storing and retrieving programs and data, wherein each of said driver modules are associated with a single one of said privilege levels;
a plurality of return addresses, wherein each of said return addresses are associated with a single one of said software applications;
a plurality of driver requests, wherein each of said driver requests is associated with a single one of said software applications and a single one of said return addresses, and said software application associated with each of said driver requests is associated with a lower privilege level than the privilege level associated with the driver to which said request is directed;
a plurality of bypass protocols that interface with said software applications, wherein each of said bypass protocols is associated with a single one of said software applications and a single one of said driver modules;
a thread trust datastore that interfaces with said driver modules, wherein the return addresses of said software applications are obtained by said driver modules and stored in said trust datastore, and one of said return addresses associated with one of said software applications may subsequently be retrieved by said driver modules, compared with one of said return addresses associated with one of said driver requests from one of said software applications, and said driver request is routed differentially based on whether said return address associated with said driver request is associated in said driver module's thread trust datastore with the requesting thread's application.

6. The computer system including an operating system and software applications of claim 5, wherein said driver request is denied if said return address of said software application does not match one of said return addresses associated with said calling thread's software application in said thread trust datastore.

7. The computer system including an operating system and software applications of claim 5, wherein said operating system is a Microsoft Windows® based operating system.

8. The computer system including an operating system and software applications of claim 5, wherein said central processing unit is an Intel®-based microprocessor.
